(19) United States
(12) Patent Application Publication
(10) Pub. No.: US 2003/0095545 A1
(43) Pub. Date: May 22, 2003

(54) Addressing scheme for management data

(76) Inventor: Howard Ngai, Southborough, MA (US)

Correspondence Address: FOGG AND ASSOCIATES, LLC, P.O. BOX 581339, MINNEAPOLIS, MN, 55458-1339, US

(21) Appl. No.: 10/265,082

(22) Filed: Oct. 4, 2002

Related U.S. Application Data
(60) Provisional application No. 60/327,084, filed on Oct. 4, 2001.

(51) Int. Cl. H04L 12/66

(52) U.S. Cl. 370/352; 370/465

(57) ABSTRACT

A communication module is provided. The communication module includes at least one communication card. The communication card has at least one port adapted to communicate packets with an external network. The communication module further includes a controller module and at least one management bus. The management bus interconnects the at least one communication card and the controller module. The first communication card includes circuitry that is adapted to recognize and encapsulate management packets for transmission over the at least one management bus to the controller module.

This application claims priority to U.S. Provisional Patent Application Serial No. 60/327,084 filed Oct. 4, 2001 and titled “Addressing Scheme for Management Data” which is commonly assigned and incorporated by reference herein.

### RELATED APPLICATION

This application is related to co-pending application Ser. No. 09/474,039 (Attorney Docket No. 11833-101), entitled SYSTEM AND PROCESS FOR HIGH-AVAILABILITY, DIRECT, FLEXIBLE, AND SCALABLE SWITCHING OF DATA PACKETS IN BROADBAND NETWORKS filed on Dec. 28, 1999 (the '833-101 Application). The '833-101 Application is incorporated herein by reference.

### TECHNICAL FIELD

The present invention relates generally to the field of telecommunications and, in particular, to an addressing scheme.

### BACKGROUND

Coaxial cable networks have been used to deliver high quality video programming to subscribers for many years. Conventionally, these networks have been unidirectional, broadcast networks with a limited number of channels and a limited variety of content provided to the subscribers. In recent years, cable companies have developed systems to provide bi-directional communication over their existing networks to provide a wider variety of services and content to their subscribers. For example, many cable companies now provide connection to the Internet through the use of cable modems.

The cable industry has developed a number of standards for delivering data over their networks to provide a uniform basis for the design and development of the equipment necessary to support these services. For example, a consortium of cable companies developed the Data Over Cable Service Interface Specifications (DOCSIS) standard. The DOCSIS standard specifies the necessary interfaces to allow for transparent, bi-directional transfer of Internet Protocol (IP) traffic between a cable head end and customer equipment over a cable or hybrid fiber/coax network.

A cable modem termination system (CMTS) is included in the head end of the cable network for processing the upstream and downstream transmission of data. In the upstream, the CMTS down converts data signals from cable modems to base band or a low intermediate frequency. The CMTS then demodulates the signals and provides the data to a network, e.g., the Internet. In the downstream, the CMTS receives data for a plurality of modems at a network interface. The CMTS modulates a carrier with this data and transmits it downstream over a shared medium, e.g., a cable or HFC network, to the plurality of modems.

One problem with the design of current CMTS equipment is in the manner that management data is communicated within a chassis. Conventionally, each card within a chassis has been provided with an Internet protocol (IP) address so that packets can be appropriately addressed to each card. This includes the chassis controller card. Unfortunately, IP addresses are not an unlimited resource. Thus, an IP address assigned to the chassis controller limits its application to other cards or devices supported by the chassis.

For the reasons stated above, and for other reasons stated below which will become apparent to those skilled in the art upon reading and understanding the present specification, there is a need in the art for an addressing scheme which reduces the number of IP addresses need in a CMTS chassis.

### SUMMARY

The above mentioned problems with addressing schemes within cable modem termination system equipment and other problems are addressed by embodiments of the present invention and will be understood by reading and studying the following specification. Specifically, embodiments of the present invention encapsulate management packets with a header that provides for routing the packet to a controller card at a layer below the network layer thus avoiding dedication of an IP address to the controller card.

In one embodiment, a communication module is provided. The communication module includes at least one communication card. The communication card has at least one port adapted to communicate packets with an external network. The communication module further includes a controller module and at least one management bus. The management bus interconnects the at least one communication card and the controller module. The first communication card includes circuitry that is adapted to recognize and encapsulate management packets for transmission over the at least one management bus to the controller module.

### BRIEF DESCRIPTION OF THE DRAWINGS

FIG. 1 is a block diagram of one embodiment of a chassis according to the teachings of the present intention.

FIG. 2 shows one embodiment of an integrated cable infrastructure having the chassis of FIG. 1.

FIG. 3 is a block diagram of one embodiment of an application card and backplane portions of the chassis of FIG. 1.

FIG. 4 is a schematic diagram of one embodiment of the backplane interconnections, including a switching mesh.

FIG. 5 is a block diagram of an embodiment of a header for encapsulating a packet according to the teachings of the present invention.

FIG. 6 is a block diagram of one embodiment of a gigabit Ethernet inter-chassis link or egress application module according to the teachings of the present invention.

FIG. 7 is a block diagram of an embodiment of a CMTS application module according to the teachings of the present invention.

FIG. 8 is a block diagram of an embodiment of an ARP table according to the teachings of the present invention.

FIG. 9 is a block diagram of an embodiment of a chassis controller module according to the teachings of the present invention.

FIG. 10 is a block diagram of an embodiment of a backplane mesh interface according to the teachings of the present invention.

FIG. 11 is a block diagram of an embodiment of a mesh communication channel (MCC) tag.

FIG. 12 is a flowchart that illustrates one embodiment of a process for encapsulating a management packet according to the teachings of the present invention.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

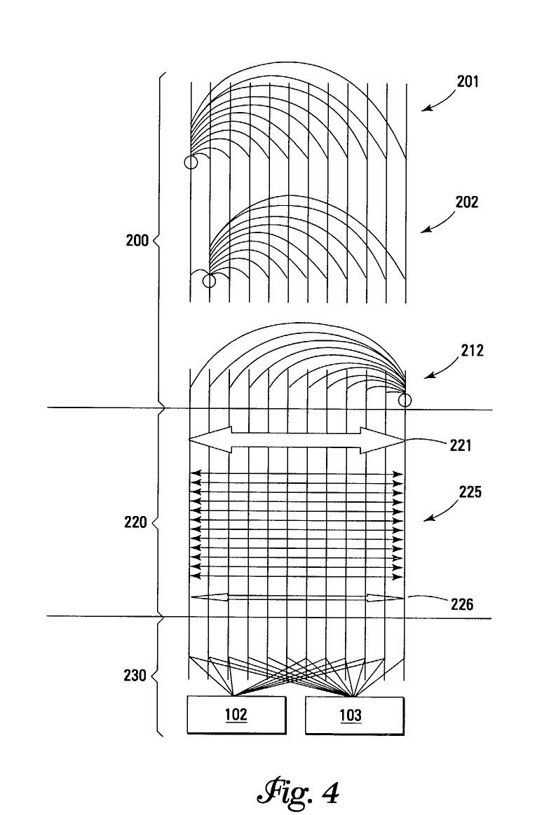

FIG. 4 shows one embodiment of a chassis 200 operating according to principles of the present invention. The chassis 200 integrates a plurality of network interfaces and applications into a single switch system. The chassis 200 is a fully-meshed IP switch with high-performance packet forwarding, filtering and Quality of Service/Class of Service (QoS/Cos) capabilities using low-level embedded software controlled by a cluster manager in a chassis controller. The packet forwarding, filtering and QoS/CoS is distributed across application modules (also called “cards”) inside chassis 200. The operations are performed in each of the modules by a fast IP processor. The chassis controller and cluster manager control the operations and configure each of the modules. Higher-level software resides in the cluster manager, including router server functions (RIPv1, RIPv2, OSFP, etc.), network management (SNMP V1/V2), security, DHCP, LDAP, and remote access software (VPNs, PPTP, L2TP, and PPP), and can be readily modified or upgraded.

In one embodiment, chassis 200 has fourteen (14) slots for modules. Twelve of those fourteen slots hold application modules 205, and two slots hold chassis controller modules 210 each application module has an on-board DC-DC converter 202 and is “hot-pluggable” into the chassis. The chassis controller modules 210 are for redundant system clock/bus arbitration. The chassis 200 also has redundant power supply modules. The power supply modules in the DC-DC converters comprise a fully distributed power supply in the chassis. Examples of applications that may be integrated in the chassis are a CMTS module 215, an Ethernet module 220, a SONET module 225, and a telephony application 230. Another application may be an inter-chassis link (ICL) port 235 through which the chassis may be linked to another chassis. The ICL port is the only egress port. The ICL port may be implemented using any egress module, e.g., 10/100 Ethernet, IG Ethernet, and Packet-over SONET (PoS).

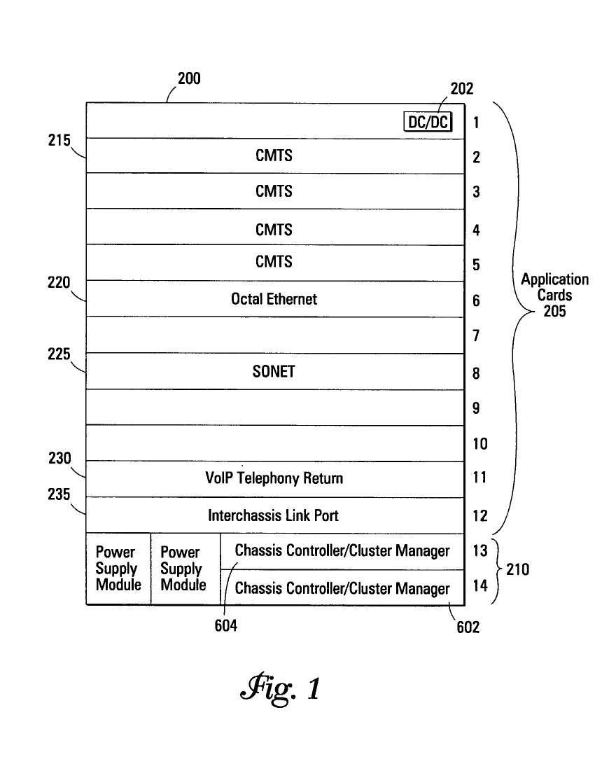

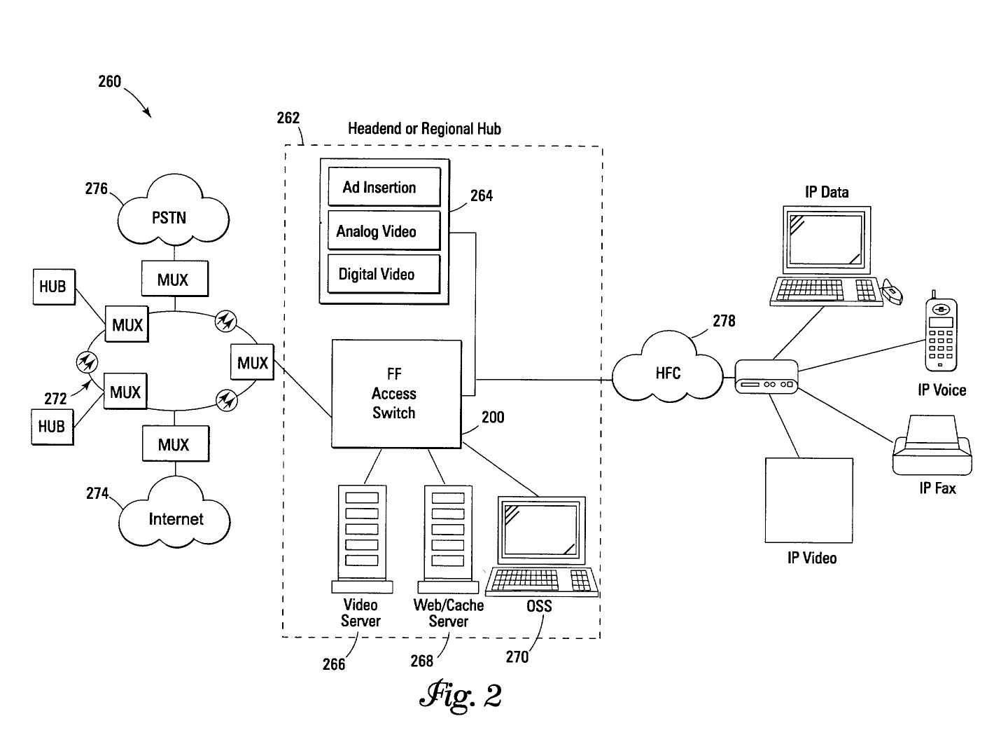

FIG. 2 shows an integrated cable infrastructure 260 having the chassis 200 of FIG. 1. The chassis 200 is part of a regional hub 262 for voice and data delivery. The hub 262 includes a video controller application 264, a video server 266, Web/cache servers 268, and operation support system (OSS) 270, all networked to the chassis 200 acting as an IP access switch. The chassis 200 is connected to a SONET ring 272, outside the hub 262, having an Internet connection 274 and a Public Switched Telephone Network (PSTN) connection 276. The chassis 200 is also connected by an HFC link 278 to cable customers and provides IP-based services including voice, data, video and fax services. Each HFC application module can handle up to 2000 cable modem service subscribers. The logical limit to the number of subscribers is 8192. The chassis can support a plurality of HFC links and also a plurality of chassis may be networked together as described in the '833-1 Application to support over one million cable modems subscribers.

By convention today, there is one wide-band channel (27-40 Mbps) for transmission (downloading) to users (which may be desktop computers, facsimile machines or telephone sets) and a plurality of narrow channels (320 kbps -10 Mbps) for uploading. This is processed by the HFC cards with duplexing at an O/E node. The local HFC cable system or loop is a coaxial cable distribution network with a drop to a cable modem.

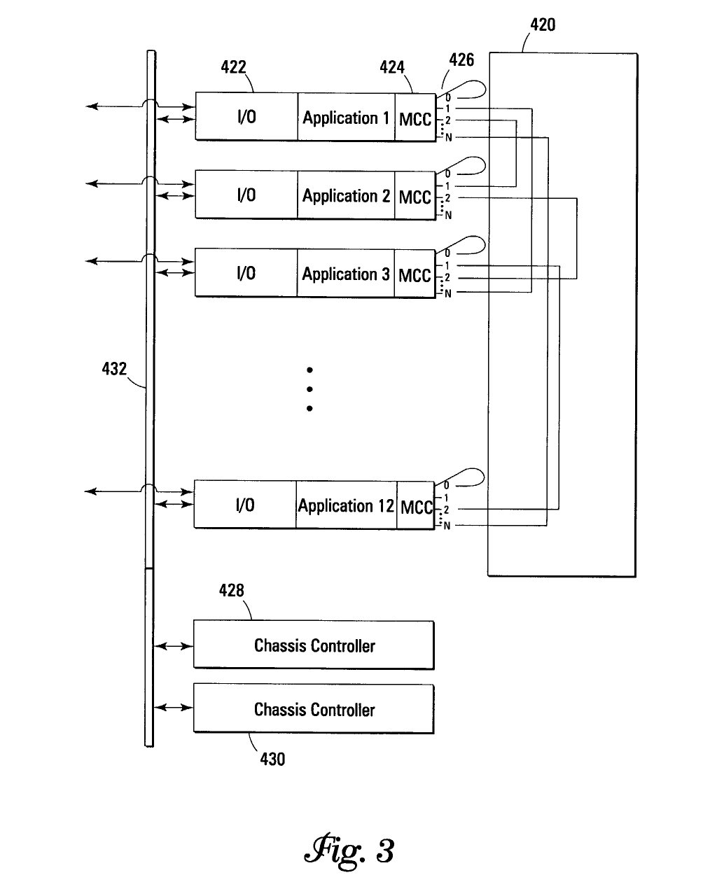

FIG. 3 shows application modules connected to a backplane 420 of the chassis 200 of FIG. 1. Each application module 422 interfaces with the backplane 420 through a Mesh Communication Chip (MCC) 424 that will be described more fully below. Each MCC 424 has twelve serial link interfaces 426, eleven that run to the backplane 420. The eleven serial links that run to the backplane on each application module are for connecting the application module to every other application module in the chassis. One link is for connecting the module with itself, i.e., a loop-back. The application modules 422 are connected to chassis controllers 428, 430 over a chassis management bus 432. The second chassis controller 430 is optionally used for redundancy in order to make the system more reliable. The second chassis management bus (not shown) is provided in one embodiment also for redundancy/reliability purposes.

The backplane is fully meshed meaning that every application module has a direct point-to-point link to every other application module in the chassis through the serial links. The meshed threads in the mesh backplane each provide a continuous direct channel for communication of data at a rate of 1.5 Gbps or greater. Only a portion of the connections 200 are shown in FIG. 3 as an example. The backplane mesh is shown in FIG. 4.

The twelve channels with serial links of the MCC are numbered 0 to 11. The number is referred to as the channel ID or CID. Channels will be described more fully below. The slots on the backplane are also numbered from 0 to 11 (slot ID, or SID). The chassis system does not require, however, that a channel 0 be wired to a slot 0 on the backplane. A serial link may be connected to any slot. The slot IDs are dynamically configured depending on system topology. This allows for freedom in backplane wiring which reduces routing complexity.

Returning to FIG. 3, each application module is also connected to a chassis management bus 432 that provides the modules a connection to the chassis controller.

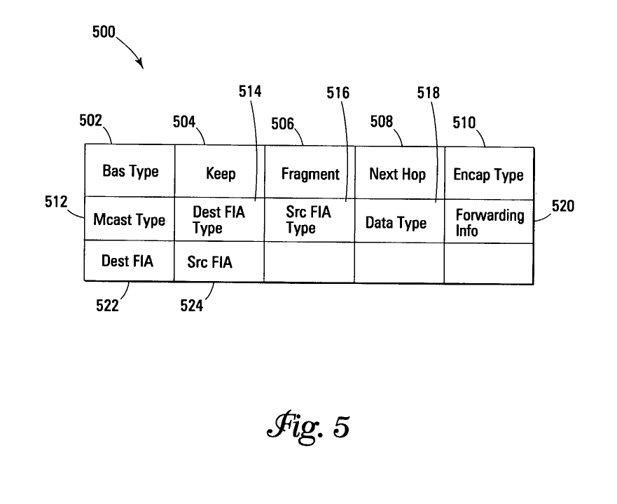

For switching packets between chassis over the inter-chassis links (ICLs) and for switching packets inside the chassis over the MCC links, the chassis has an inter-chassis switching layer. The inter-chassis switching layer lies below the IP layer 3 (L3, the network layer). Packet processing in the chassis is broken down into two types of traffic: unicast and broadcast/multicast. Switching through the inter-chassis switching layer is accomplished using the inter-chassis header 500 (also called the inter-chassis tag) shown in FIG. 5. The various fields of the inter-chassis tag of FIG. 5 are described with respect to FIG. 13 of the '833-1 Application, which description is incorporated herein by reference.

According to the system architecture, all application cards that plug into the chassis share common features. The application cards are also called data processors, data processing application module, data communications module, and communication cards.

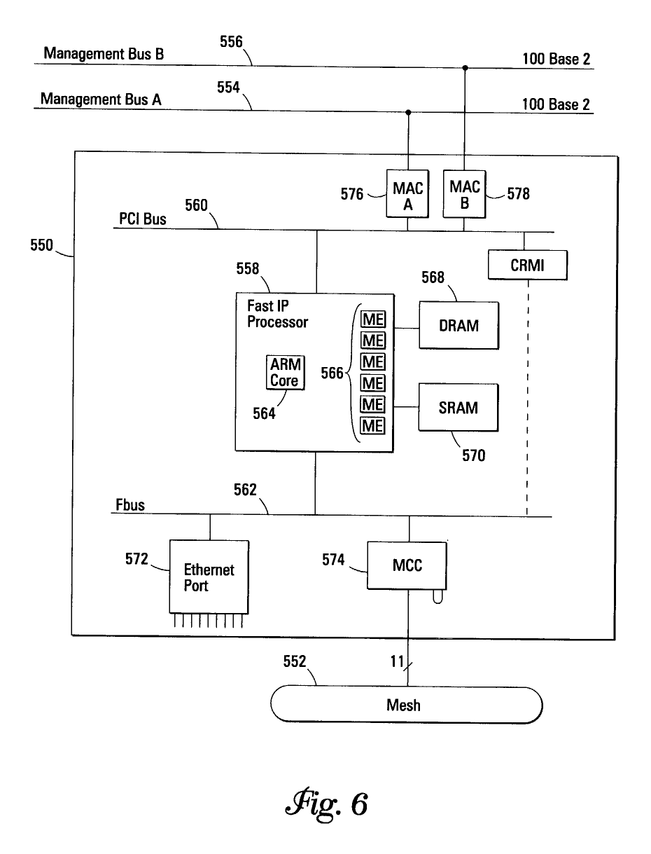

FIG. 6 is a block diagram of an Ethernet application module 550 in the chassis. The application module is connected to both the mesh backplane 552 and to the management busses A 554 and B 556. In the Ethernet application module 550, a fast IP processor (FIPP) 558 is connected to both a PCI bus 560 and an F-bus 562. The FIPP 558 has an advanced RISC machine (ARM) processor core 564 and six micro-engines 566. The FIPP 558 is connected to a DRAM 568 for storing packets and an SRAM 570 for storing a routing table. An Ethernet device 572 having eight ports is connected to the F-bus 562. An MCC 574 is also connected to the F-bus. The MCC 574 provides the connections to the mesh backplane 552. The Ethernet device 572 provides connections to the outside of the chassis. Two MAC devices are connected between the PCI bus 560 and the management busses. MAC A 576 is connected between the PCI bus 560 and the management bus A 554. MAC B 578 is connected between the PCI bus 560 and management bus B 556.

When a data packet comes into the Ethernet device 572, it goes through the FIPP 558 and is stored in the DRAM 568. The micro-engines 566 examine the data packets in parallel. The micro-engines 566 look at the IP address in the packets and then look up the destination address in the forwarding table stored in the SRAM 570. The forwarding table provides the chassis, slot and port that the packet will go out on. When the packet comes in over the Ethernet device, the packet has an Ethernet header. If the packet goes out the same slot through which it came, an inter-chassis header is not applied. The FIPP determines the sending port and sends the packet out of that port. If the packet is to exit by a different slot, the Ethernet header is removed and an inter-chassis header is added to the data packet. The minimum information in the inter-chassis header is destination data, chassis, slot, and port information. The packet further includes an IP header and a payload. The FIPP has transmit queues where the packets are queued before transmission. The packets are sent over the F-bus 562 to the MCC 574 which sends data out in 64-byte chunks.

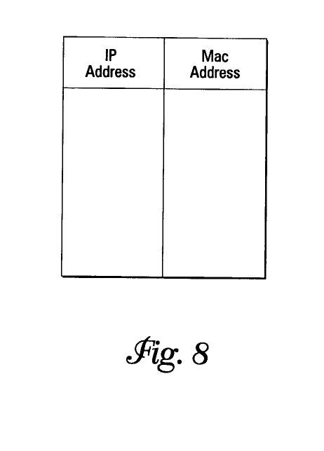

When the packet comes in through the MCC 574 of the Ethernet module 550, the application module 550 puts the packet, or pointers to the packet, into a queue in DRAM 570. If the packet is to go out one of the serial ports, the FIPP 558 looks up the destination in the ARP table in the SRAM 570. The ARP table is shown in FIG. 8. The FIPP finds the chassis, slot and port. The chassis address does not change unless the destination is an ICL. In the case of the same chassis, the application module finds the MCC address for the IP packet and sends it out. If the packet is to go to some other chassis, the application module asks if any port is an ICL. If it is, the application module sends the packet out of that port.

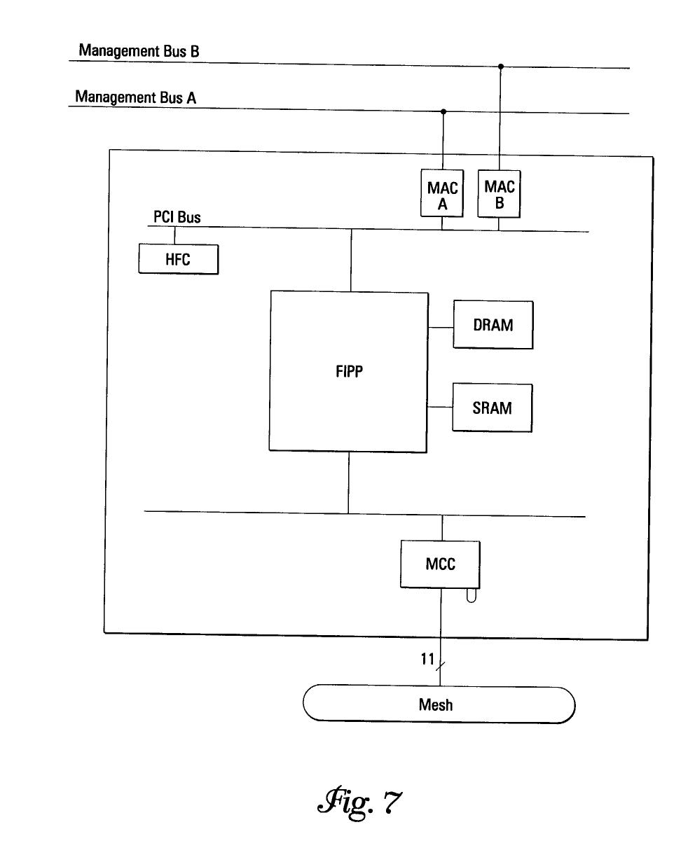

FIG. 7 shows the CMTS application card, also referred to as an HFC DOCSIS Interface card. HFC-on-PCI technology is currently used because of currently available Broadcom technology, however, in the future other types of interface technology may be used.

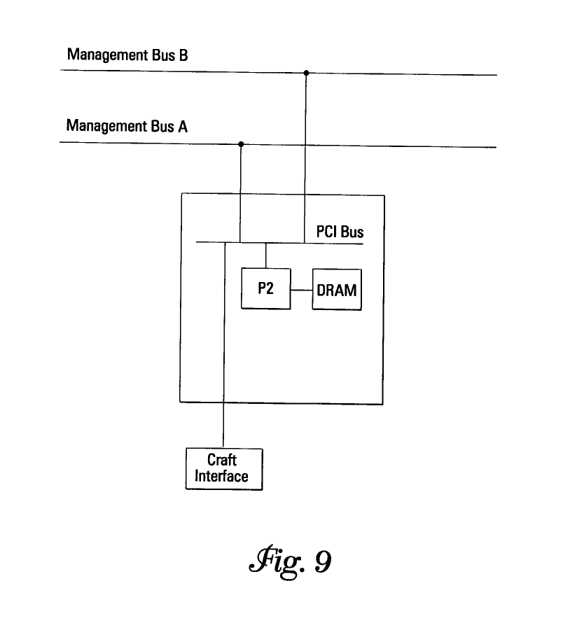

FIG. 9 shows a chassis controller connected to the management busses in the chassis. For redundancy, each chassis has two chassis controllers. The chassis controller is not connected to the mesh backplane. The chassis controller has network management tasks and provisioning tasks. The chassis controller enables an entire chassis cluster to appear to be one managed element as described in the '833-1 Application. The chassis controller has a processor and memory and a craft interface. In one embodiment, the processor is a Pentium processor. The craft interface is a network management interface using 10/100 base Ethernet.

The chassis controller communicates with the application modules in the chassis over the management busses. The chassis controller and application modules each have an agent for communication purposes. The chassis controller has a master agent and the application modules have subagents. The subagents communicate their chassis, application module, and slot information to the master agent in the chassis.

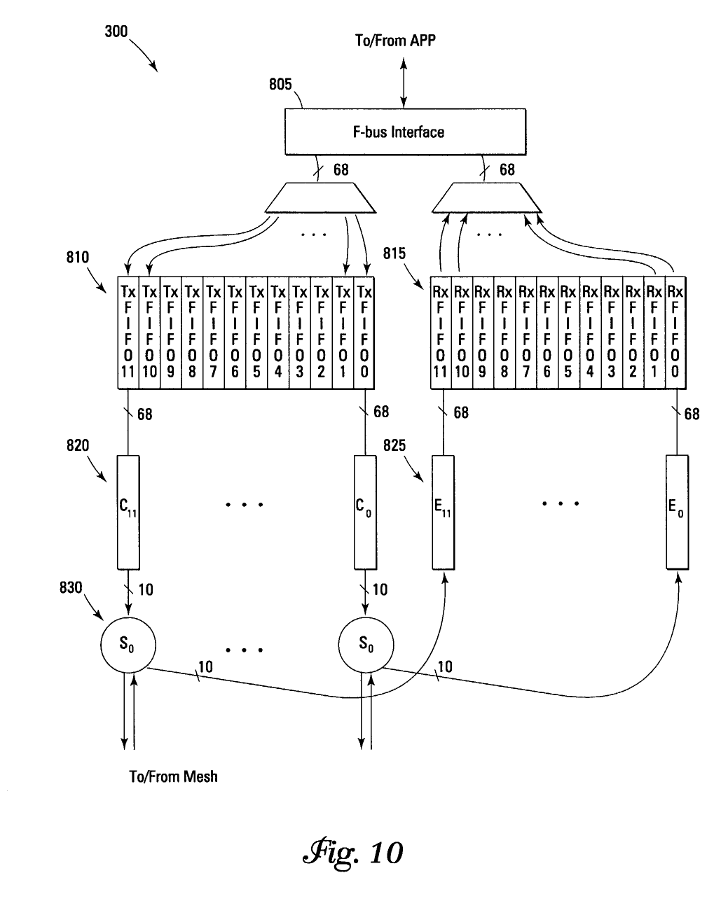

FIG. 10 is a block diagram of one embodiment of the mesh communication chip (MCC). The MCC ASIC provides connectivity to all other cards and the chassis via high-speed differential pairs shown as fully duplexed serial links 215. Each differential pair operates at greater than 1 gigabit per second data throughput. An F-bus interface 805 connects the MCC 300 to the FIFO bus (F-bus). Twelve transmit FIFOs 810 and 12 receive FIFOs 815 are connected to the F-bus interface 805. Each transmit FIFO has a parallel to serial data compressor (12 data compressor in all, 820), and each receive FIFO has a data expander (12 data expanders in all, 825). Twelve serializers 830 serve the data compressors 820 and data expanders 825, one compressor and one expander for each serializer. The channel in the MCC is defined as a serial link together with its encoding/decoding logic, transmit queue and receive queue. The serial lines running from the channels connect to the backplane mesh. All the channels can transmit data at the same time.

In one embodiment, a mesh communication chip interconnects up to 13 F-busses in a full mesh using serial link technology. Each MCC has two F-bus interfaces and 12 serial link interfaces. The MCC transmits and receives packets on the F-busses in programmable size increments from 64 bytes to entire packets. It contains 12 virtual transmit processors (VTPs) which take packets from the F-bus and send them out of the serial links, allowing twelve outgoing packets simultaneously. The VTPs read the MCC tag on the front of the packet and dynamically bind themselves to the destination slot(s) indicated in the header.

The cards/slot-specific processor cards/slot-specific MAC/PHY pair (Ethernet, SONET, HFC, etc.) and an MCC communicate on a bi-directional F-bus (or multiple unidirectional F-busses). The packet transmit path is from the PHY/MAC to the processor, then from the processor to the MCC and out the mesh. The processor does Layer 3 and Layer 4 look-ups in the FIPP to determine the packet's destination and Quality of Service (QoS), modifies the header as necessary, and prepends the MCC tag to the packet before sending it to the MCC.

The packet receive path is from the mesh to the MCC and onto the processor, then from the processor to the MAC/PHY and out the channel. The processor strips off the MCC tag before sending the packet onto the MAC.

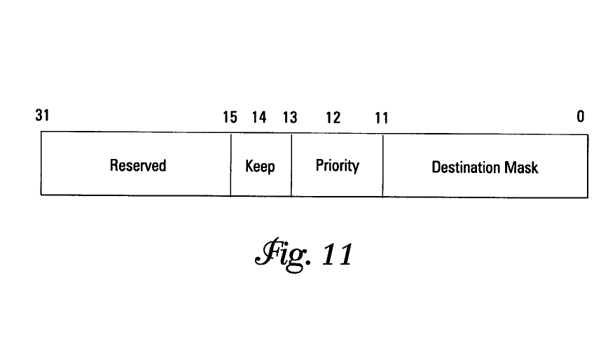

FIG. 11 shows a packet tag, also called the MCC tag. The packet tag is a 32-bit tag used to route a packet through the backplane mesh. The tag is added to the front of the packet by the slot processor before sending it to the MCC. The tag has four fields: a destination mask field, a priority field, a keep field, and a reserved field. The destination mask field is the field holding the mask of slots in the current chassis to which the packet is destined, which may or may not be the final destination in the system. For a transmit packet, the MCC uses the destination mask to determine which transmit queue(s) the packet is destined for. For a receive packet, the MCC uses the priority and keep field to determine which packets to discard in an over-committed slot.

The MCC has two independent transmit mode selectors, slot-to-channel mapping and virtual transmit mode. In slot-to-channel mapping, the MCC transparently maps SIDs to CIDs and software does not have to keep track of the mapping. In virtual transmit mode, the MCC handles multicast packets semi-transparently. The MCC takes a single F-bus stream and directs it to multiple channels. The transmit ports in the MCC address virtual transmit processors (VTPs) rather than slots. The F-bus interface directs the packet to the selected virtual transmit processor. The virtual transmit processor saves the destination mask field from the MCC tag and forwards the packet data (including the MCC tag) to the set of transmit queues indicated in the destination mask. All subsequent 64-byte “chunks” of the packet are sent by the slot processor using the same port ID, and so are directed to the same virtual transmit processor. The virtual transmit processor forwards chunks of the packet to the set of transmit queues indicated in the destination mask field saved from the MCC tag. When a chunk arrives with the EOP bit set, the virtual transmit processor clears its destination mask. If the next chunk addressed to the port is not the start of the new packet (i.e., with the SOP bit set), the virtual transmit processor does not forward the chunk to any queue.

The MCC maintains a set of “channel busy” bits which it uses to prevent multiple virtual transmit processors from sending packets to the same CID simultaneously. This conflict prevention mechanism is not intended to assist the slot processor in management of busy channels, but rather to prevent complete corruption of packets in the event that the slot processor accidentally sends two packets to the same slot simultaneously. When the virtual transmit processors get a new packet, they compare the destination CID mask with the channel busy bits. If any channel is busy, it is removed from the destination mask and an error is recorded for that CID. The virtual transmit processor then sets all the busy bits for all remaining destination channels and transmits the packet. When the virtual transmit processor sees EOP on the F-bus for the packet, it clears the channel busy bits for its destination CIDs.

The F-Bus interface performs the I/O functions between the MCC and remaining portion of the application module. The application module adds a 32-bit packet tag, shown in FIG. 11, to each data packet to be routed through the mesh.

The data received or transmited on the F-bus is up to 64 bits wide. In data transmission, the F-bus interface adds 4 status bits to the transmit data to make a 68-bit data segment. The F-bus interface drops the 68-bit data segment into the appropriate transmit FIFO as determined from the packet tag. The data from a transmit FIFO is transferred to the associated data compressor where the 68-bit data segment is reduced to 10-bit segments. The data is then passed to the associated serializer where the data is further reduced to a serial stream. The serial stream is sent out the serial link to the backplane.

Data arriving from the backplane comes through a serial link to the associated channel. The serializer for the channel expands the data to a 10-bit data segment and the associated data expander expands the data to a 68-bit data segment which is passed on to the related FIFO and then from the FIFO to the F-bus interface.

A fast IP processor (FIPP) is provided with 32/64 MB of high-speed synchronous SDRAM, 8 MB of high-speed synchronous SDRAM, and boot flash. The FIPP has a 32-bit PCI bus and a 64-bit FIFO bus (F-bus). The FIPP transfers packet data to and from all F-bus-connected devices. It provides IP forwarding in both unicast and multicast mode. Routing tables are received over the management bus from the chassis route server. The FIPP also provides higher layer functions such as filtering, and CoS/QoS.

Each line card has a clock subsystem that produces all the clocks necessary for each card. This will lock to the reference clock provided by the system clock and management bus arbitration card.

Each card has hot-plug, power-on reset circuitry, and sanity timer functions. All cards have on-board DC-to-DC converters to go from the −48V rail in the backplane to whatever voltages are required for the application. Some cards (such as the CMTS card) likely will have two separate and isolated supplies to maximize the performance of the analog portions of card.

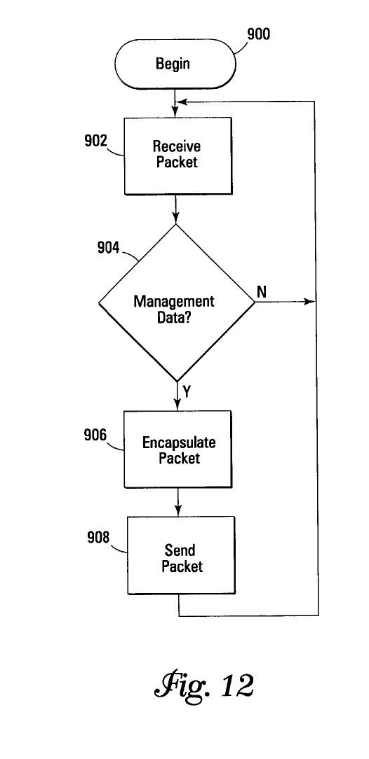

FIG. 12 is a flowchart of a process for handling management packets received at an application card (e.g., a communication card) of a communication module such as chassis 200 of FIG. 1 according to one embodiment of the present invention. In one embodiment, the process operates as software code stored on the application card.

The process begins at block 900. At block 902, the process receives a packet and the application or communication card. In one embodiment, a fast IP processor of the application card analyzes the packets to determine whether the packet is a management packet at 904. For example, in one embodiment, the fast IP processor determines whether the packet received at the application card is a simple network management protocol (SNMP) packet or other appropriate management packet. If the packet is not a management packet, the process returns to block 902 and the packet is handled as described above.

If, however, the packet is determined to be a management packet, the method proceeds to block 906. At block 906, the method encapsulates the packet by adding an inter-chassis header, such as shown and described above with respect to FIG. 5, to the packet. The inter-chassis header indicates that the packet is destined for a chassis controller such as chassis controller 602 or 604 in slots 13 and 14 of chassis 200. Finally, at block 908, the process sends the packet to the designated chassis controller based on the information in the inter-chassis header. Advantageously, by encapsulating management packets in this manner, a service provider does not need to waste an IP address on either of the chassis controllers. The process returns to block 902.

Although specific embodiments have been illustrated and described herein, it will be appreciated by those of ordinary skill in the art that any arrangement, which is calculated to achieve the same purpose, may be substituted for the specific embodiments shown. For example, in other embodiments, the process of FIG. 12 can be used to route management packets of other types to the chassis controller without an IP address. This application is intended to cover any adaptations or variations of the present invention. Therefore, it is intended that this invention be limited only by the claims and the equivalents thereof.

What is claimed is:

1. A communication module, comprising:
at least one communication card, having at least one port adapted to communicate packets with an external network;
a controller module;
at least one management bus, coupled to interconnect the at least one communication card and the controller module; and
wherein the first communication card includes circuitry that is adapted to recognize and encapsulate management packets for transmission over the at least one management bus to the controller module.

2. The communication module of claim 1, wherein the at least one communication card is identified with an Internet Protocol (IP) address.

3. The communication module of claim 1, wherein the at least one communication card includes an IP processor that is programmed to recognize and encapsulate the management packets.

4. The communication module of claim 1, wherein the at least one communication card includes an IP processor that is programmed to recognize and encapsulate simple network management protocol (SNMP) packets.

5. The communication module of claim 1, wherein the at least one communication card comprises one of an Ethernet card, a cable modem termination system (CMTS) card and a packet over SONET (POS) card.

6. A method for routing a packet containing management data to a controller card in a communication module, the method comprising:
receiving the packet containing management data at a port of a communication card;
recognizing the packet as containing management data;
encapsulating the packet containing management data with a header that identifies the controller card as the destination of the packet containing management data; and
sending the encapsulated packet containing management data to the controller card.

7. The method of claim 6, wherein receiving the packet containing management data comprises receiving a simple network management protocol (SNMP) packet.

8. The method of claim 6, wherein sending the encapsulated packet containing management data to the controller comprises sending the encapsulated packet over a management bus.

9. A communication module, comprising:
at least one chassis with multiple identical interfaces to a mesh having mesh threads providing a plurality of continuous direct channels for communication of data between pairs of the interfaces;
at least one communication card with at least one data port adapted for connecting to a network, the module engaging one of the interfaces of the chassis and responsive to information in data received through one of the ports to route the data to selected ones of the mesh threads to which the module is interfaced;
at least one controller module adapted to configure and control the operation of the at least one communication card;
at least one management bus, coupled to interconnect the at least one communication card and the controller module; and
wherein the first communication card includes circuitry that is adapted to recognize and encapsulate management packets for transmission over the at least one management bus to the controller module.

10. The communication module of claim 9, wherein the at least one communication card is identified with an Internet Protocol (IP) address.

11. The communication module of claim 9, wherein the at least one communication card includes an IP processor that is programmed to recognize and encapsulate the management packets.

12. The communication module of claim 9, wherein the at least one communication card includes an IP processor that is programmed to recognize and encapsulate simple network management protocol (SNMP) packets.

13. The communication module of claim 9, wherein the at least one communication card comprises one of an Ethernet card, a cable modem termination system (CMTS) card and a packet over SONET (POS) card.

14. A method for routing a simple network management protocol (SNMP) packet to a controller card in a communication module, the method comprising:
receiving the SNMP packet at a port of a communication card;
recognizing the SNMP packet;
encapsulating the SNMP packet with a header that identifies the controller card as the destination of the SNMP packet; and
sending the encapsulated SNMP packet to the controller card over a management bus.

15. A communication module, comprising:
a plurality of communication cards, each having at least one port adapted to communicate packets with an external network;
a controller module;
a chassis having a mesh, adapted to receive the plurality of communication cards and the controller module, and adapted for communicating data between selected ones of the plurality of communication cards; and
wherein each of the communication cards includes circuitry that is adapted to recognize and encapsulate management packets for transmission to the controller module.

16. The communication module of claim 15, wherein the at least one communication card is identified with an Internet Protocol (IP) address.

17. The communication module of claim 15, wherein the at least one communication card includes an IP processor that is programmed to recognize and encapsulate the management packets.

18. The communication module of claim 15, wherein the at least one communication card includes an IP processor that is programmed to recognize and encapsulate simple network management protocol (SNMP) packets.

19. The communication module of claim 15, wherein the at least one communication card comprises one of an Ethernet card, a cable modem termination system (CMTS) card and a packet over SONET (POS) card.

20. A communication module, comprising:
at least one chassis with multiple identical interfaces to a mesh having mesh threads providing a plurality of continuous direct channels for communication of data between pairs of the interfaces;
at least one communication card, identified with an Internet Protocol (IP) address with at least one data port adapted for connecting to a network, the module engaging one of the interfaces of the chassis and responsive to information in data received through one of the ports to route the data to selected ones of the mesh threads to which the module is interfaced;
at least one controller module adapted to configure and control the operation of the at least one communication card;
at least one management bus, coupled to interconnect the at least one communication card and the controller module; and
wherein the first communication card includes an IP processor that is adapted to recognize and encapsulate management packets for transmission over the at least one management bus to the controller module.

21. The communication module of claim 20, wherein the IP processor is programmed to recognize and encapsulate simple network management protocol (SNMP) packets.

22. The communication module of claim 20, wherein the at least one communication card comprises one of an Ethernet card, a cable modem termination system (CMTS) card and a packet over SONET (POS) card.

23. A computer readable medium for causing a computer to execute a method for routing a simple network management protocol (SNMP) packet to a controller card in a communication module, the method comprising:
receiving the SNMP packet at a port of a communication card;
recognizing the SNMP packet;
encapsulating the SNMP packet with a header that identifies the controller card as the destination of the SNMP packet; and
sending the encapsulated SNMP packet to the controller card over a management bus.
